(19) United States
(12) Patent Application Publication
(10) Pub. No.: US 2006/0173113 A1
(43) Pub. Date: Aug. 3, 2006

(54) Powder coating composition and coating method of aluminum wheel

(75) Inventors: Masami Yabuta, Neyagawa-shi (JP); Nobuo Iga, Neyagawa-shi (JP); Tomoya Tsuji, Neyagawa-shi (JP); Yuji Toyoda, Neyagawa-shi (JP)

Correspondence Address: CONNOLLY BOVE LODGE & HUTZ LLP, SUITE 800, 1990 M STREET NW, WASHINGTON, DC, 20036-3425, US

(73) Assignee: Nippon Paint Co., Ltd., Osaka-shi (JP)

(21) Appl. No.: 11/344,009

(22) Filed: Feb. 1, 2006

(30) Foreign Application Priority Data
Feb. 1, 2005 (JP) 2005-025492

(51) Int. Cl. B05D 3/02; C08K 9/12; C08K 3/08

(52) U.S. Cl. 524/439; 427/384; 427/407.1; 523/210

(57) ABSTRACT

It is an object of the present invention to provide a powder coating composition, which can exhibit a sufficient hiding power, a corrosion resistance and an excellent appearance and can reduce a coating process and is particularly suitable for coating of an aluminum wheel because of its high low temperature curability and has excellent storage stability, and a coating method of an aluminum wheel using the same. A powder coating composition consisting of a powder coating composition particle, wherein said powder coating composition particle comprises at least a thermosetting resin powder formed by binding a metallic pigment with a binder and
said thermosetting resin powder comprises a β-hydroxyalkylamide curing agent expressed by the following general formula (1): 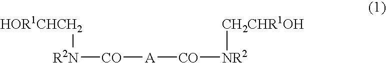
wherein R¹ represents a hydrogen atom, a methyl group or an ethyl group, R² represents a hydrogen atom, an alkyl group having 1 to 5 carbon atoms or HOCH(R¹)CH₂—, and A represents a bivalent hydrocarbon group.

### TECHNICAL FIELD

The present invention relates to a powder coating composition and a coating method of an aluminum wheel.

### BACKGROUND ART

In coating an aluminum wheel with a metallic coating composition containing a metallic pigment in flake form, the steps of primer-coating with a powder coating composition and top-coating with a solvent-borne metallic coating composition have been generally performed. In such a method, since the steps are many, there is a requirement to reduce them and a reduction in an organic solvent usage is also required.

As a powder coating composition for coating an aluminum wheel, there is known a coating composition containing a β-hydroxyalkylamide curing agent, for example, in Japanese Kokai Publication 2001-294804. Since the β-hydroxyalkylamide curing agent can cause a curing reaction to occur at low temperatures, it is a preferable compound from the viewpoint of reducing energy consumption in a curing step. Further, since if the molded aluminum substrate is treated at elevated temperatures, its strength is decreased, the β-hydroxyalkylamide curing agent capable of curing at low temperatures is also preferred in point of preventing such a problem. However, there is no description of a powder coating composition in which a metallic pigment in flake form is mixed in Japanese Kokai Publication 2001-294804. Accordingly, this method has problems to be improved described above.

As a powder coating composition containing metallic pigment in flake form, there is known a powder coating composition obtained by binding a thermosetting resin powder to a metallic pigment in flake form using a binder, for example, in Japanese Kokai Publication 2004-175813. However, in this publication, there is not disclosed a powder coating composition adapted to be suitable for coating of an aluminum wheel.

### SUMMARY OF THE INVENTION

It is an object of the present invention to provide a powder coating composition, which can exhibit a sufficient hiding power, a corrosion resistance and an excellent appearance and can reduce a coating process and is particularly suitable for coating of an aluminum wheel because of its high low temperature curability and has excellent storage stability, and a coating method of an aluminum wheel using the same.

The present invention pertains to a powder coating composition consisting of a powder coating composition particle,

wherein the powder coating composition particle comprises at least a thermosetting resin powder formed by binding a metallic pigment with a binder and

the thermosetting resin powder comprises a β-hydroxyalkylamide curing agent expressed by the following general formula (1): 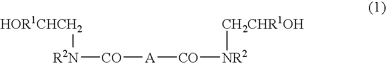
wherein R¹ represents a hydrogen atom, a methyl group or an ethyl group, R represents a hydrogen atom, an alkyl group having 1 to 5 carbon atoms or HOCH(R¹)CH₂—, and A represents a bivalent hydrocarbon group.

The metallic pigment is preferably bound to the surface of the thermosetting resin powder.

The metallic pigment is preferably a metallic pigment in flake form.

A binding ratio of the metallic pigment to the thermosetting resin powder is preferably 90 to 100%.

An average particle diameter of the powder coating composition particles is preferably 100 μm or less on the D50 equivalent basis.

The binder is preferably an organic compound having a number average molecular weight of 300 to 2000 and a softening point of 30 to 180° C.

The binder is preferably one or more species selected from the group consisting of terpene resins, terpene-phenolic resins, hydrogenated terpene resins and hydrogenated terpene-phenolic resins.

Preferably, the thermosetting resin powder has an average particle diameter of 5 to 50 μm.

Preferably, the powder coating composition particle comprises a carboxyl group-containing polyester resin.

Preferably, the powder coating composition particle further comprises an epoxy group-containing vinyl-based resin and/or an epoxy resin.

The present invention also pertains to a coating method of an aluminum wheel, comprising the steps of: (1-1) applying the above-mentioned powder coating composition and (1-2) curing the applied powder coating composition at a temperature of 150 to 170° C.

The present invention also pertains to a coating method of an aluminum wheel, comprising the steps of: (2-1) applying the above-mentioned powder coating composition, (2-2) curing the applied powder coating composition at a temperature of 150 to 170° C., (2-3) applying a clear coating composition onto the cured coating film formed by the step (2-2), and (2-4) curing the applied clear coating composition.

The present invention also pertains to a coating method of an aluminum wheel, comprising the steps of: (3-1) applying the above-mentioned powder coating composition, (3-2) applying a clear coating composition onto the coat applied by the step (3-1), and (3-3) curing the coats applied by the steps (3-1) and (3-2) at a temperature of 150 to 170° C.

### DETAILED DESCRIPTION OF THE INVENTION

Hereinafter, the present invention will be described more detail.

A powder coating composition of the present invention is a powder coating composition consisting of a powder coating composition particle, and the above-mentioned powder coating composition particle comprises at least a thermosetting resin powder obtained by binding a metallic pigment with a binder. When such a powder coating composition is used, it can exhibit a sufficient hiding power, a corrosion resistance and an excellent appearance and has good low temperature curability, and therefore, it is particularly suitable for coating of an aluminum wheel. And, since it has excellent adhesion to an article to be coated, it can form a coating film containing a metallic pigment in flake form without performing primer coating, and therefore a coating process is reduced and efficient coating can be done.

The above-mentioned thermosetting resin powder comprises a β-hydroxyalkylamide curing agent expressed by the following general formula (1): 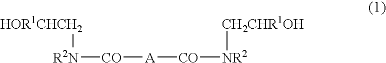
wherein R¹ represents a hydrogen atom, a methyl group or an ethyl group, and R² represents a hydrogen atom, an alkyl group having 1 to 5 carbon atoms or HOCH(R¹)CH₂—, and A represents a bivalent hydrocarbon group. The β-hydroxyalkylamide curing agent is preferred in that it can cause a curing reaction to occur at low temperature.

As R¹ in the above general formula (1), a hydrogen atom or a methyl group is preferred, and as R², HOCH(R¹)CH₂— is preferred, and as A, a hydrocarbon group having 2 to 10 carbon atoms is preferred and an alkylene group having 4 to 8 carbon atoms is more preferred.

The above β-hydroxyalkylamide curing agent can be obtained by reacting, for example, carboxylic acid and/or carboxylate with β-hydroxyalkylamine in the presence of a catalyst of alkoxides such as sodium alkoxide or potassium alkoxide.

Examples of the above carboxylic acid or carboxylate include, for example, succinic acid, adipic acid, glutaric acid, dimethyl succinate, diethyl succinate and dimethyl adipate. Examples of β-hydroxyalkylamine can include, for example, N-methylethanolamine, diethanolamine and N-methylpropanolamine.

Examples of a thermosetting resin used in combination with the β-hydroxyalkylamide curing agent in the thermosetting resin powder are not particularly limited and can include, for example, an acrylic resin, a polyester resin, an alkyd resin, a urea resin, a melamine resin, a phenolic resin, and ebonite. It is more preferred to use a carboxyl group-containing polyester resin because of good coating film properties.

A mixing ratio of the above carboxyl group-containing polyester resin to the above β-hydroxyalkylamide curing agent is preferably such a ratio that (the equivalent weight of a carboxyl group in the carboxyl group-containing polyester resin)/(the equivalent weight of a hydroxyl group of the β-hydroxyalkylamide curing agent) is 0.6/1 to 1/0.6. The above ratio is more preferably 0.8/1 to 1/0.8. When the ratio is out of this range, functional strength and water resistance of a coating film may be deteriorated.

In the above-mentioned carboxyl group-containing polyester, its resin solids preferably have an acid value of 10 to 100 (mg KOH/g solids: hereinafter the same shall apply), more preferably 15 to 80, and furthermore preferably 20 to 60. When this acid value is less than 10, curability may be reduced and mechanical properties may be deteriorated, and when it is more than 100, the water resistance of a coating film to be obtained may be deteriorated. And, it preferably has a softening point of 80 to 150° C. and more preferably has a softening point of 90 to 130° C. When it has a softening point of less than 80° C., its blocking resistance may be deteriorated, and when it has a softening point of more than 150° C., the smoothness of a coating film to be obtained may be deteriorated. Further, it preferably has a weight average molecular weight of 1000 to 150000, more preferably has a weight average molecular weight of 3000 to 70000, and furthermore preferably has a weight average molecular weight of 4000 to 50000. When the weight average molecular weight is less than 1000, the performance and the properties of a coating film to be obtained may be deteriorated, and when it is more than 150000, the smoothness and the appearance of a coating film to be obtained may be deteriorated.

In addition, the acid value of resin solids and the softening point in the present invention can be determined by methods according to JIS K 0070 and JIS K 2207, respectively. And, the weight average molecular weight and the number average molecular weight in the present invention can be determined by publicly known methods such as a gel permeation chromatography (GPC). The above carboxyl group-containing polyester resin may be a compound of two or more species, and in that case, the above-mentioned properties and characteristics refer to values as a whole compound.

The above carboxyl group-containing polyester resin can be obtained by polycondensating an acid component based on polyhydric carboxylic acid and an alcohol component based on polyhydric alcohol as raw materials by a normal method. By selecting the respective components and the conditions of polycondensation, a carboxyl group-containing polyester resin having the above properties and characteristics can be obtained.

Examples of the above acid component are not particularly limited and include, for example, terephthalic acid, isophthalic acid, phthalic acid, trimellit, and anhydrides thereof; aromatic dicarboxylic acids such as 2,6-naphthalenedicarboxylic acid and 2,7-naphthalenedicarboxylic acid, and anhydrides thereof; saturated aliphatic dicarboxylic acids such as succinic acid, adipic acid, azelaic acid, sebacic acid, dodecanedicarboxylic acid and 1,4-cyclohexanedicarboxylic acid, and anhydrides thereof; lactones such as γ-butyrolactone and ε-caprolactone, and hydroxycarboxylic acids corresponding thereto; and aromatic oxymonocarboxylic acids such as p-oxyethoxybenzoic acid, and the above acid component may be used in combination of two or more species of them.

Examples of the above alcohol component are not particularly limited and include, for example, diols such as ethylene glycol, 1,3-propanediol, 1,4-butanediol, 1,5-pentanediol, 1,5-hexanediol, diethylene glycol, triethylene glycol, 1,4-cyclohexane diol, 1,4-cyclohexane dimethanol, alkyleneoxide adducts of bisphenol A, alkyleneoxide adducts of bisphenol S, 1,2-propanediol, neopentyl glycol, 1,2-butanediol, 1,3-butanediol, 1,2-pentanediol, 2,3-pentanediol, 1,4-pentanediol, 1,4-hexanediol, 2,5-hexanediol, 3-methyl-1,5-pentanediol, 1,2-dodecanediol and 1,2-octadecanediol; and polyhydric alcohols which is trivalent or higher such as trimethylol propane, glycerin and pentaerythritol, and the above alcohol component may be used in combination of two or more species of them.

The powder coating composition of the present invention preferably comprises an epoxy group-containing vinyl-based resin and/or an epoxy resin together with the above carboxyl group-containing polyester resin. Thereby, the low temperature curability and the storage stability of a powder coating composition are more enhanced.

The above-mentioned epoxy group-containing vinyl-based resin is a vinyl-based copolymer having an epoxy group on the terminal or the side chain of a molecule, and it may be a compound of two or more species. An epoxy equivalent weight of the epoxy group-containing vinyl-based resin is preferably 250 to 1500 from the viewpoint of the storage stability of a powder coating composition, the mechanical properties and the water resistance of a coating film to be obtained and the like, more preferably 300 to 1000, and furthermore preferably 400 to 900. When this epoxy equivalent weight is less than 250, a solid-phase reaction tends to proceed and the storage stability may be deteriorated, and when it is more than 1500, the mechanical properties and the water resistance of a coating film may be deteriorated. And, the above epoxy group-containing vinyl-based resin preferably has a softening point of 80 to 150° C. When its softening point is out of this range, the blocking resistance and the smoothness of a coating film may be deteriorated. Further, it preferably has a number average molecular weight of 300 to 10000 from the viewpoint of the mechanical properties and the smoothness of a coating film and more preferably has a number average molecular weight of 1000 to 5000. When the number average molecular weight is less than 300, the mechanical properties may be deteriorated, and when it is more than 1000, the smoothness may be deteriorated.

The above epoxy group-containing vinyl-based resin can be obtained by copolymerizing a vinyl monomer having an epoxy group with another vinyl monomer as required, or by introducing an epoxy group into a vinyl-based copolymer.

When the above epoxy group-containing vinyl-based resin is obtained by polymerization using a vinyl monomer having an epoxy group, examples of the above-mentioned vinyl monomer having an epoxy group are not particularly limited and include various glycidyl esters of (meth)acrylic acid such as glycidyl (meth)acrylate, β-methylglycidyl (meth)acrylate and the like; and various alicyclic epoxy group-containing vinyl-based monomers such as 3,4-epoxycyclohexyl acrylate, 3,4-epoxycyclohexyl methacrylate and the like.

Examples of another vinyl monomer can include (meth)acrylate esters such as methyl (meth)acrylate, ethyl (meth)acrylate, butyl (meth)acrylate, cyclohexyl (meth)acrylate, benzyl (meth)acrylate and the like; hydroxyl group-containing (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate and the like; various α-olefins such as ethylene, propylene, butane-1 and the like; various aromatic vinyl compounds such as styrene, α-methylstyrene, vinyl toluene and the like; and vinyl esters such as vinyl acetate, vinyl propionate, vinyl butyrate and the like.

Examples of the above method of introducing an epoxy group into a vinyl-based copolymer include, for example, a method of reacting a vinyl-based copolymer having an isocyanate group with glycidol.

As the above epoxy resin, there is used, for example, a substance having 1.1 or more epoxy groups on average in a molecule. Specifically, there are used a product of a reaction of a novolac type phenolic resin with epichlorohydrin; a bisphenol type epoxy resin (A type, B type, F type, etc.); a hydrogenated bisphenol type epoxy resin; a product of a reaction of a novolac type phenolic resin and a bisphenol type epoxy resin (A type, B type, F type, etc.) with epichlorohydrin; a product of a reaction of a novolac type phenolic resin with a bisphenol type epoxy resin (A type, B type, F type, etc.); a product of a reaction of a cresol compound such as cresol novolac with epichlorohydrin; glycidyl ethers obtained by a reaction of alcohol compounds such as ethylene glycol, propylene glycol, 1,4-butanediol, polyethylene glycol, polypropylene glycol, neopentyl glycol and glycerol with epichlorohydrin; glycidyl esters obtained by a reaction of carboxylic acid compounds such as succinic acid, adipic acid, sebacic acid, phthalic acid, terephthalic acid, hexahydrophthalic acid and trimellitic acid with epichlorohydrin; a product of a reaction of hydroxycarboxylic acid such as p-oxybenzoic acid and β-oxynaphthoic acid with epichlorohydrin; alicyclic epoxy compounds such as
3,4-epoxy-6-methylcyclohexylmethyl-3,4-epoxy-6-methylcyclohexane carboxylate and
3,4-epoxycyclohexylmethyl(3,4-epoxycyclohexane)carboxylate;
   triglycidyl isocyanurate (TGIC) and its derivatives. Two or more species of these compounds may be used in combination.

An epoxy equivalent weight of the above epoxy resin is preferably 100 to 4000 and more preferably 100 to 2000. When the epoxy equivalent weight is less than 100, the storage stability of a coating composition may be deteriorated, and when it is more than 4000, the water resistance of a coating film may be deteriorated. Incidentally, the epoxy equivalent weight in the present invention can be determined according to JIS K 7236.

Examples of a commercially available of such an epoxy resin can include EPOTOHTO YD-128, EPOTOHTO YD-014, EPOTOHTO YD-019, ST-5080, ST-5100, ST-4100D (every produced by Tohto Kasei Co., Ltd.), EHPA-3150 (produced by DAICEL CHEMICAL INDUSTRIES, LTD.), Araldite CY179 (produced by Nihon Ciba-Geigy K.K.), Denacol EX-711 (produced by Nagase Chemicals Ltd.), EPOTOHTO YDPN-639, EPOTOHTO YDCN-701, EPOTOHTO YDCN-701 (every produced by Tohto Kasei Co., Ltd.), EPICLON N-680, EPICLON N-695, EPICLON HP-4032, EPICLON HP-7200H (every produced by DAINIPPON INK AND CHEMICALS, INCORPORATED), Araldite PT 810, Araldite PT 910 (produced by Nihon Ciba-Geigy K.K.), and TEPIC (produced by Nissan Chemical Industries, Ltd.).

Preferable contents of the respective components of the carboxyl group-containing polyester resin, the epoxy group-containing vinyl-based resin, the epoxy resin and the β-hydroxyalkylamide curing agent in the powder coating composition of the present invention are as follows.

The content of the above epoxy group-containing vinyl-based resin is preferably 0.1 to 10 parts by weight per 100 parts by weight of the carboxyl group-containing polyester resin from the viewpoint of the mechanical properties, the water resistance and the smoothness of a coating film, the storage stability of a coating composition and the like, more preferably 1 to 10 parts by weight and furthermore preferably 2 to 9 parts by weight. When the content is less than 0.1 parts by weight, the mechanical properties of a coating film may be reduced or the water resistance of a coating film may become faulty, and when it is more than 10 parts by weight, the smoothness of a coating film may be deteriorated or a reaction of a carboxyl group and an epoxy group may proceed during the storage of a coating composition and this may result in reduction in the storage stability of a coating composition.

An amount of the above epoxy resin to be mixed is preferably 0.1 to 10 parts by weight per 100 parts by weight of the carboxyl group-containing polyester resin from the viewpoint of the water resistance of a coating film, the storage stability of a coating composition and the like, more preferably 1 to 10 parts by weight and furthermore preferably 2 to 9 parts by weight. When this amount is less than 0.1 parts by weight, the water resistance of a coating film may become faulty, and when it is more than 10 parts by weight, a reaction of a carboxyl group and an epoxy group may proceed during the storage of a coating composition and this may results in deterioration in the storage stability of a coating composition.

Further, it is preferred to contain the β-hydroxyalkylamide curing agent in such a way that a ratio of the total equivalent weights of the equivalent weight of an epoxy group of the epoxy group-containing vinyl-based resin and the equivalent weight of an epoxy group of the epoxy resin, which is an overall equivalent weight of epoxy groups contained in solids of the powder coating composition of the present invention, to the equivalent weight of a hydroxyl group of the β-hydroxyalkylamide curing agent is 0.05/1 to 1/1, and it is preferred to contain the β-hydroxyalkylamide curing agent in such a way that the above ratio is more preferably 0.1/1 to 0.8/1 and furthermore preferably 0.1/1 to 0.6/1. Reactivity of a carboxyl group in the carboxyl group-containing polyester resin with a hydroxyl group of the β-hydroxyalkylamide curing agent at room temperature is lower than that with an epoxy group. Accordingly, adapting in such a way that the above ratio is within the above range results in the existence of a quantity of a hydroxyl group of the β-hydroxyalkylamide curing agent in the powder coating composition, which is larger than that of an epoxy group, and therefore the reaction does not proceed so much at low reaction temperature like room temperature, and consequently the storage stability of a coating composition becomes good. Accordingly, when the above ratio is more than 1/1, the storage stability of a coating compositon may be deteriorated, and when it is less than 0.05/1, a reaction of an epoxy group of the epoxy group-containing vinyl-based resin and an epoxy group of the epoxy resin with a carboxyl group of the carboxyl group-containing polyester resin is reduced, and the mechanical properties and the water resistance of a coating film in baking at a low temperature may be deteriorated.

A ratio of the equivalent weight of a carboxyl group of the carboxyl group-containing polyester resin to the total of the epoxy equivalent weight of the above epoxy group-containing vinyl-based resin, the equivalent weight of an epoxy group of the epoxy resin and the equivalent weight of a hydroxyl group of the β-hydroxyalkylamide curing agent is preferably 0.5/1 to 1.6/1, and more preferably 0.7/1 to 1.3/1. If this ratio is within this range, a curing reaction proceeds normally, but if the ratio is less than 0.5/1, curing becomes insufficient and the mechanical properties and the water resistance of a coating film may be deteriorated. When it exceeds 1.6/1, the water resistance of a coating film may be deteriorated.

And, particularly when an acid value of the carboxyl group-containing polyester resin is in a range of 10 to 45, it is preferred that the above-mentioned equivalent weight ratio is in a range of 0.9/1 to 1.3/1. If the above ratio is within this range, a curing reaction proceeds just enough, and the mechanical properties and the water resistance of a coating film become good and it is preferred.

When the low temperature curability is particularly enhanced by increasing the above acid value of the carboxyl group-containing polyester resin to 45 to 100 which is higher than the acid value adopted in common powder coating compositions, the above-mentioned equivalent weight ratio is preferably 0.7/1 to 1.1/1. If this ratio is out of this range, the mechanical properties and the water resistance of a coating film may be deteriorated.

The above thermosetting resin powder may contain as required a curing agent other than β-hydroxyalkylamide curing agent; a dispersant; a surface control agent; various fluid adjusters such as silica, alumina and aluminum hydroxide; various flowing agents such as acrylic oligomer and silicone; various antifoaming agents such as benzoin; and various additives and various functional material, which are used in a powder coating composition, such as waxes, a coupling agent, an antioxidant, a magnetic powder, a stabilizer, an ultraviolet absorber, a leveling agent, a thickner, an anti-settling agent, a plasticizer, an anti-popping agent and an antistatic agent.

As the above-mentioned surface control agent, there is preferably used a surface control agent comprising an acrylic polymer having a number average molecular weight of 300 to 50000 and a glass transition point of less than 20° C., which is obtained from a raw material of alkyl esters of (meth)acrylic acid. When this molecular weight is out of the above range, it is impossible to adequately provide a surface controlling property and the prevention of an appearance defect such as depression may becomes inadequate. And, when the glass transition point is not less than 20° C., it may be impossible to adequately provide a surface controlling property. A content of the surface control agent is preferably 0.01 to 5% by weight in the powder coating composition, more preferably 0.05 to 3% by weight and furthermore preferably 0.1 to 2% by weight. When this content is less than 0.01% by weight, it is impossible to adequately provide a surface controlling property and the probability of the appearance defect may increase, and when it is more than 5% by weight, the blocking resistance of a coating composition may be reduced.

Examples of a commercially available of the above surface control agent include, for example, Acronal 4F (produced by BASF Japan Ltd.), POLYFLOW S (produced by KYOEISHA CHEMICAL Co., LTD.) and Resiflow LV (produced by ESTRON CHEMICAL, INC.), and a silica carrier acrylic polymers such as Modaflow III (produced by Monsanto Japan Ltd.) and Resiflow P67 (produced by ESTRON CHEMICAL, INC.) are suitably used. And, a mixture of an acrylic polymer which is a surface control agent and an epoxy resin may be used on adjusting in such a way that usage of the epoxy resin falls within the above range.

The above flow modifier can not only impart the fluidity to the powder coating composition itself but also enhance the blocking resistance. As the flow modifier, hydrophobic silica, hydrophilic silica, aluminum oxide and titanium oxide can be applied. Examples of a commercially available of the above flow modifier include, for example, AEROSIL 130, AEROSIL 200, AEROSIL 300, AEROSIL R-972, AEROSIL R-812, AEROSIL R-812S, titanium dioxide T-805, titanium dioxide P-25 and Aluminum Oxide C (produced by NIPPON AEROSIL CO., LTD.) and CARPREX FPS-1 (produced by SHIONOGI & CO., LTD.). An amount of the flow modifier to be added is preferably set at 0.05 to 2 parts by weight per 100 parts by weight of the powder coating composition and more preferably set at 0.1 to 1 part by weight from the viewpoint of an effect to be provided and the smoothness of a coating film. When this amount is less than 0.05 parts by weight, the effect becomes small, and when it is more than 2 parts by weight, the smoothness of a coating film may be deteriorated and matting may occur.

The above thermosetting resin powder may contain a coloring pigment, a coloring agent, an extender pigment, a rust-preventive pigment and a matting agent. Amounts of these components to be mixed, although varying with the species of a component, is preferably adjusted within a range in which the features of the above metallic pigment is capitalized on and the smoothness and the mirrorlike reflection property of the surface of a coating film are not impaired. As these a coloring pigment, a coloring agent, an extender pigment, a rust-preventive pigment and a matting agent, there can be used materials which are commonly used in a coating composition.

Examples of the above coloring pigment and coloring agent are not particularly limited and can include, for example, quinacridone, diketopyrrolopyrrole, isoindolinone, indanthrone, perylene, perynone, anthraquinone, dioxazine, benzoimidazolone, triphenylmethane quinophthalone, anthrapyrimidine, chrome yellow, pearl mica, clear pearl mica, colored mica, interference mica, phthalocyanine, halogenated phthalocyanine, azo pigment (azomethine metal complex, condensed azo, etc.), titanium oxide, carbon black, iron oxide, copper phthalocyanine and condensed polycyclic compound pigments.

An average particle diameter of the above thermosetting resin powder is not particularly limited but in general, it is preferably 5 to 100 μm. A lower limit of the above range of the average particle diameter is preferably 15 μm and an upper limit of the above range is more preferably 60 μm and furthermore preferably 50 μm. When the above average particle diameter is less than 5 μm, it becomes difficult to mix the thermosetting resin powder with the pigment and the cohesive property of the thermosetting resin powder becomes large, and therefore there is a possibility that uniform fine particles cannot be obtained during powder coating. When it is more than 100 μm, there is a possibility that the smoothness of the surface of a coating film may be impaired and therefore the good appearance cannot be attained. The above average particle diameter of the thermosetting resin powder is determined by calculating a volume average from a particle size distribution measured by publicly known measuring methods of a particle size distribution such as a laser diffraction method, a micromesh sieve method, a coulter Counter and the like.

Examples of a production method of the above thermosetting resin powder can include, for example, the following method. First, raw material compositions such as a resin, a curing agent and filler to be added as required are dry blended with a mixer, a blender or the like, and after mixing, the raw materials are melted and kneaded at 80 to 120° C. with a kneader and cooled. Next, the melted mixture is solidified by being cooled with a chill roll or a cooling conveyer, and the mixture melted, kneaded and cooled is crushed with a mechanical or airflow type crusher, subjected to the steps of rough grinding and fine grinding and milled to a desired particle size. Then, by classifying the milled resin with an air classifier, a thermosetting resin powder can be obtained. The thermosetting resin powder can be also produced by a spray drying method or a polymerization method other than this method.

A metallic pigment used in the powder coating composition of the present invention is a highly reflective pigment and includes a metal flake of aluminum, zinc, copper, bronze, nickel, titanium or stainless steel and an alloy flake thereof, and one or more species of the metallic pigments can be used. The metallic pigment is preferably a metallic pigment in flake form, which has a low-profile shape. Among others, an aluminum flake pigment has an excellent metallic gloss and is easy to handle because of a low specific gravity, and therefore it is particularly suitable.

In general, an average particle diameter of the above metallic pigment is preferably 1 to 100 μm, and more preferably 3 to 60 Lm. In general, an average thickness of the above metallic pigment is preferably 0.01 to 5 μm, and more preferably 0.02 to 2 μm. Further, the metallic pigment having a shape factor, which is defined by dividing the average particle diameter by the average thickness, of 5 to 100 is particularly preferred.

When the above average particle diameter of the metallic pigment is more than 100 μm, since the metallic pigment protrudes through the surface of a coating film, the smoothness and the mirrorlike reflection property of a coated surface may be deteriorated, and when it is less than 1 μm, a metallic feeling and a glitter tends to decrease. When the average thickness is more than 5 μm, the smoothness and the mirrorlike reflection property of a coated surface may be deteriorated, and when it is less than 0.01 am, the strength of a coated surface may be reduced and cutting process of a coated aluminum wheel may become difficult during a manufacturing process.

The above average particle diameter of the metallic pigment is determined by calculating a volume average from a particle size distribution measured by publicly known measuring methods of a particle size distribution such as a laser diffraction method, a micromesh sieve method, a Coulter Counter method and the like. The average thickness is calculated from a hiding power and a density of the metallic pigment in flake form.

The surface of the metallic pigment may adsorb an additive which has been added in grinding a pigment. Examples of the additive include, for example, fatty acids (oleic acid, stearic acid), aliphatic amines, aliphatic amides, aliphatic alcohols and ester compounds. These compounds have an effect of inhibiting unnecessary oxidation at the metallic pigment surface and improving the gloss. An amount of the additive to be adsorbed is preferably less than 2 parts by weight per 100 parts by weight of the metallic pigment. When this amount is 2 parts by weight or more, the surface gloss may be deteriorated.

In the present invention, various coloring agents or coloring pigments may adhere to the surface of the metallic pigment in order to provide a variety of colors for the metallic pigment. A substance described above can be used as the coloring agent and the coloring pigment.

The above metallic pigment may be provided with an interference coat on the surface. Examples of a method of forming the above interference coat are not particularly limited and can include, for example, a method in which a coat oxidized by air is formed on the surface by heating a metallic flake to about 300 to 700° C. in an atmosphere where oxygen content is controlled, and a method in which a metallic pigment is covered with an oxide precursor such as transition metal and the oxide precursor is decomposed by heat.

The above metallic pigment may be a metallic pigment which has a resin layer formed on the surface of the metallic pigment in order to provide chemical resistance, water resistance and weather resistance. As a method of forming the resin layer on the surface of the metallic pigment, there is preferably used a method in which a raw material composition, which contains at least two species of oligomers and/or monomers having at least a polymerizable double bond, is added to the slurry formed by dispersing a metallic flake in an organic solvent and a polymer is precipitated by adding a polymerization initiator to the mixture while heating the mixture in an atmosphere of an inert gas.

When the above metallic pigment is an aluminum flake pigment, an amount (herein, it is also referred to as an amount of a resin coat) of a coat of a resin composition (herein, it is also referred to as a resin coat), which is formed on the surface of an aluminum flake pigment, is preferably 2 g or more, and more preferably 5 g or more per 100 g of the aluminum flake pigment.

When the amount of a resin coat is less than 2 g, effects by a resin coat such as weather resistance and chemical resistance may become insufficient. When the amount of a resin coat is more than 50 g, a binding ratio may be reduced.

The powder coating composition of the present invention is one obtained by binding a metallic pigment to a thermosetting resin powder with a binder. Thereby, it is possible to attain effects of (1) changing the color on the occasion of recycling and recoating the powder coating composition, (2) preventing color irregularity (metal irregularity) and (3) inhibiting the cohesion of a aluminum flake. The metallic pigment is bound to the thermosetting resin powder by the above binder and the metallic pigment is preferably bound to the surface of the thermosetting resin powder. The reason for this is that a glitter is more improved by binding to the surface.

The above binder is not particularly limited as long as it is a compound having a function of binding the above thermosetting resin powder to the metallic pigment, and it can be selected in accordance with species of a thermosetting resin powder and metallic pigment, which are used.

The above binder is preferably an organic compound having a number average molecular weight of 300 to 2000. A lower limit of the above range of the number average molecular weight is more preferably 400 and an upper limit is more preferably 1500. When the number average molecular weight is less than 300, the binder becomes liquid at room temperature and therefore blocking may occur between the thermosetting powder coating composition resins, and when it is more than 2000, the binder may become hard to uniformly permeate or disperse in the thermosetting powder coating composition resin.

A softening point of the above binder is preferably 30 to 180° C. A lower limit of the above range of the softening point is more preferably 80° C. and an upper limit of the above range is more preferably 150° C. When the softening point is less than 30° C., blocking may occur between the thermosetting powder coating composition resins, and when it is more than 180° C., the binder may become hard to uniformly permeate or disperse in the thermosetting powder coating composition resin.

As a compound which can be used as the above binder, there are suitably used one or more species selected from the group consisting of binders of natural resin such as coumarone-indene resins, terpene resins, terpene-phenolic resins, aromatic hydrocarbon modified terpene resins, hydrogenated terpene resins, hydrogenated terpene-phenolic resins, rosin resins, hydrogenated rosin ester resins, rosin modified phenolic resins and alkylphenolic resins; binders of synthetic resin such as alkylphenol-acetylene resins, alkylphenol-formaldehyde resins styrenic resins, aliphatic petroleum resins, alicyclic petroleum resins, copolymer petroleum resins, aromatic petroleum resins, xylene resins and xylene-formaldehyde resins; oligomer tackifiers such as polybutene and liquid rubber; and others such as various rubber materials, fats and oils and waxes. Among these resins, there are suitably used one or more species selected from the group consisting of terpene resins, terpene-phenolic resins, hydrogenated terpene resins and hydrogenated terpene-phenolic resins.

A method of binding the above metallic pigment to the surface of the above thermosetting resin powder with a binder is not particularly limited and for example, the following method can be employed.

To a premixture formed by uniformly mixing the thermosetting resin powder and the metallic pigment in advance, a binder dissolved in a solvent is added and the resulting mixture was kneaded. The mixture is kept on kneading until the solvent is evaporated and the whole mixture becomes powder, and after removing the solvent entirely, the resulting powder is classified with a screen classifier to obtain a powder coating composition for metallic coating. By evaporating and removing the solvent while kneading the mixture to dry the mixture, a binding force between the metallic pigment and the thermosetting resin powder can be enhanced and simultaneously the blocking between the powder resins can be inhibited. In addition, it is more preferred to perform vacuum aspiration at the occasion of evaporating and removing a solvent and drying a mixture.

The above step of kneading is preferably performed in a temperature range of −5 to 50° C. When the temperature range is more than 50° C., blocking of the thermosetting resin powder may occur.

Examples of a solvent for dissolving the above binder is not particularly limited and can include, for example, alkanes such as pentane, hexane, heptane, octane and the like; isoparaffins such as isopentane, isohexane, isoheptane, isooctane and the like; alcohols such as methanol, ethanol and the like; organic halogenides such as carbon tetrachloride and the like; and water.

The metallic pigment to be mixed in the above thermosetting resin powder is preferably mixed generally in an amount of 1 to 40 parts by weight per 100 parts by weight of the thermosetting resin powder and more preferably in an amount of 2 to 20 parts by weight. When this amount is less than 1 part by weight, it may be impossible to attain a metallic feeling and a glitter adequately. When it is more than 40 parts by weight, the smoothness of a coating film may be lost and the appearance of a coating film may be deteriorated.

An amount of the above binder to be added is preferably 0.1 to 5% based on a powder coating composition to be obtained. When this amount is less than 0.1%, a large amount of a metallic pigment liberated due to insufficient binding may remain, and when it is more than 5%, blocking may occur.

A binding ratio of the above metallic pigment to the above thermosetting resin powder in the powder coating composition of the present invention is preferably in a range of 90 to 100% and more preferably in a range of 95% or more. When the binding ratio is less than this range, a problem that the metallic pigment adheres to a gun nozzle due to static electricity may arise. This problem is remarkable particularly in an aluminum flake pigment. The above binding ratio refers to a rate of the metallic pigment particles binding to the surface of the thermosetting resin powder with respect to overall metallic pigment particles, and it can be measured by a method described below.

Measuring Method of Binding Ratio (Bonding Ratio)

(i) Principle of Measurement of Binding Ratio

The binding ratio of the metallic pigment to the thermosetting resin powder is determined by quantifying the metallic pigment not binding to the thermosetting resin powder and subtracting the ratio of the metallic pigment not binding as shown in the following equation.
Binding ratio (%)=100−ratio of metallic pigment not binding (%)

Here, in order to quantify the metallic pigment not binding, the metallic pigment (liberated metallic pigment) to which the thermosetting resin powder does not bind has to be separated from the metallic pigment to which the thermosetting resin powder binds.

(ii) Measurement of Metallic Pigment Content

A certain amount of the powder coating composition was sampled, and then only a metallic pigment coated with a coat of the resin composition is extracted by dissolving and removing the thermosetting resin powder with N-methylpyrrolidone, and a weight of the extracted metallic pigment is measured, and thereby the metallic pigment content in the powder coating composition is determined.

Quantification and separation of the metallic pigment not binding to the thermosetting resin powder can be determined by a quantifying method and a separation method of a liberated aluminum flake pigment described in Japanese Kokai Publication 2004-175813.

An average particle diameter of powder coating composition particles contained in the powder coating composition of the present invention is preferably 100 μm or less on the D50 equivalent basis and preferably 10 μm or more on the D50 equivalent basis.

The powder coating composition of the present invention can form a coating film by being applied to an article to be coated (substrate) and then being heated.

The powder coating composition of the present invention can be applied to a variety of materials but it is particularly suitable for coating of aluminum. It is applied to, for example, car bodies, office supplies, household articles, sporting-goods, construction materials, and household electrical appliances as a specific usage pattern and it is particularly suitable for coating an aluminum wheel.

In a method of coating the powder coating composition of the present invention, it is preferred that the surface of a substrate is previously treated by blasting and publicly known treatment such as chemical conversion treatment is applied to the surface, and then the powder coating composition is applied to the surface and cured by heat. The above chemical conversion treatment is preferably non-chromate treatment or the like from the viewpoint of the environmental protection and zirconium treatment can be given as non-chromate treatment. The powder coating composition of the present invention has excellent adhesion to the aluminum surface treated by zirconium treatment.

A coating film obtained from the powder coating composition of the present invention can reduce the coating process since it has a good adhesion property, a good protection function and an excellent appearance even when a single layer is formed without using a primer.

As a method of applying the powder coating composition of the present invention to the surface of a substrate, publicly known methods such as a spray coating method, a fluidized bed coating method, an electrostatic powder coating method and the like can be applied, but the electrostatic powder coating method is preferable in coating efficiency and preferred. Examples of the method of electrostatic powder coating include a corona discharge process and a frictional electrification process.

As the conditions of heat setting the powder coating composition of the present invention, although varying depending on the amounts of a functional group and a curing accelerator involved in curing, for example, a heating temperature is preferably 100 to 230° C., more preferably 140 to 200° C., and particularly preferably 150 to 170° C. A heating time can be appropriately set in accordance with a heating temperature, but in general, it may be set at a time period of 1 minute or more and preferably a time period of 5 to 30 minutes. In addition, a film thickness of a coat in the case of applying the powder coating composition of the present invention is not particularly limited but it is preferred to apply the powder coating composition in such a way that the thickness of a coating film formed by heating is 20 to 200 μm.

The powder coating composition of the present invention can be used for forming a single layer coating film obtained by “one coat-one bake” process (that is a film-forming process having a single coating step and a following single baking step), but it can also be used for forming a multilayer coating film. Particularly, a method of forming a multilayer coating film by applying a clear coating composition onto a coating film formed from the powder coating composition of the present invention is preferred. The formation of the multilayer coating film is suitably employed in both of “two-coat and two-bake” process (that is a film-forming process having the first coating step, the first baking step, the second coating step, and the second baking step in this order), and “two-coat and one-bake” process (that is a film-forming process having a multilayer coating step and a following single baking step). Among others, it can be employed particularly suitably for the two-coat and one-bake process.

A clear coating composition, which can be used in the above method of forming the multilayer coating film, is not particularly limited and a solvent-borne clear coating composition, a water-borne clear coating composition and a powder clear coating composition can be used. Among others, a high solid type (HS) clear coating composition and a powder clear coating composition are preferred.

When the multilayer coating film is formed by the two-coat and one-bake process using the powder coating composition of the present invention, it is preferred that after a powder coating composition is applied to form a coat and then the coat formed from the powder coating composition is smoothed by preheating the coat, a clear coating composition is applied to the smoothed coating film. Thereby, a multilayer coating film having a good appearance can be formed. The above preheating is preferably performed, for example, at a temperature of 100 to 200° C.

The coating methods of an aluminum wheel like this, i.e., (1) the method comprising the steps of (1-1) applying the above powder coating composition and (1-2) curing the applied powder coating composition at a temperature of 150 to 170° C.; (2) the method comprising the steps of (2-1) applying the above powder coating composition, (2-2) curing the applied powder coating composition at a temperature of 150 to 170° C., (2-3) applying a clear coating composition onto the cured coating film formed by the step (2-2), and (2-4) curing the applied clear coating composition; and (3) the method comprising the steps of (3-1) applying the above powder coating composition, (3-2) applying a clear coating composition onto the coat applied by the step (3-1), and (3-3) curing the coats applied by the steps (3-1) and (3-2) at a temperature of 150 to 170° C., also constitute the present invention.

Since the powder coating composition and the coating method of an aluminum wheel of the present invention are constituted as described above and are superior in the workability of coating and can exhibit a sufficient hiding power, an excellent corrosion resistance and an excellent appearance through one coat, they can reduce a coating process. In addition, they can be suitably used particularly for producing an aluminum wheel metallic appearance because of its high low temperature curability.

### BEST MODES FOR CARRYING OUT THE INVENTION

Hereinafter, the present invention will be described in more detail by way of examples, but the present invention is not limited to these examples.

<Preparation of a Treated Aluminum Plate for Performance Evaluation>

An aluminum alloy (AC-4C) test panel was degreased and rinsed with water, and then after it was subjected to acid pickling, rinsing with water, chemical conversion treatment, rinsing with water, post-treatment and drying under the following conditions, powder coating was carried out. Rinsing was carried out through showering of running water, and all of the respective steps were carried out in a dipping system. Drying was carried out at 120° C. for 25 minutes with an electric drier.

(A) Degreasing solution: 2% (weight/volume) SURFCLEANER 53 (produced by Nippon Paint Co., Ltd.)

Treating temperature: 50° C., treating time: 3 minutes

(B) Acid pickling treatment solution: 3% (weight/volume) SURFCLEANER 355A (produced by Nippon Paint Co., Ltd.; FeSO₄.7H₂O 0.81 g/L, 98% sulfuric acid 12.1 g/L, pH 0.9)

Treating temperature: 40° C., treating time: 3 minutes

(C) Chemical conversion treating solution: 2.5% (weight/volume) ALSURF 501N-1 (produced by Nippon Paint Co., Ltd.; zirconium phosphate treating agent; (NH₄)₂ZrF₆ 0.12 g/L, 75% H₃PO₄ 0.10 g/L, 55% HF 0.02 g/L, 42% HBF₄ 0.16 g/L, pH 3.5)

Treating temperature: 40° C., treating time: 45 seconds

(D) Post-treatment treating solution: it was prepared by diluting POWERNIX 110F-2 (produced by Nippon Paint Co., Ltd.; component, modified epoxy emulsion; nonvolatile content 36% by weight) with water in such away that a content of resin solids is 2% by weight. Treating temperature: 25° C., treating time: 1 minute

<Production of Powder Coating Composition>

Powder Coating Composition 1

Using 100 parts by weight of FINEDIC M8962 (produced by DAINIPPON INK AND CHEMICALS, INCORPORATED, acid value 33, softening point 112° C.), 5 parts by weight of FINEDIC A241 (produced by DAINIPPON INK AND CHEMICALS, INCORPORATED, epoxy group-containing vinyl-based polymer, epoxy equivalent weight 600, softening point 109° C.), 5 parts by weight of EPOTOHTO YD-014 (produced by Tohto Kasei Co., Ltd., epoxy resin, epoxy equivalent weight 950), 5 parts by weight of Primid XL-552 (produced by EMS-PRIMD, β-hydroxyalkylamide curing agent which is expressed by the following formula (2), hydroxyl group equivalent weight 84), 0.5 parts by weight of Acronal 4F (produced by BASF Japan Ltd., a surface control agent, acrylic polymer, Tg −55° C., solubility parameter (SP) 9.3, a number average molecular weight of 16500), 1 part by weight of benzoin and 65 parts by weight of TIPAQUE CR-90 (produced by ISHIHARA SANGYO KAISHA, LTD., rutile titanium dioxide pigment) as raw materials, these compounds were mixed for about 3 minutes with a mixer Super Mixer (produced by Nihon Spindle Manufacturing Co., Ltd.) and further melted and kneaded at about 110° C. with a melting kneader Co kneader (produced by Buss Co.). Here, Primid XL-552 is a material expressed by the following formula (2).

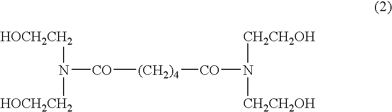

Then, after the obtained substance melted and kneaded was cooled to room temperature, it was milled with a mill atomizer (produced by Fuji Paudal Co., Ltd.) and the resulting powder was classified with a air classifier DS-2 type (produced by Nippon Pneumatic Mfg. Co., Ltd.) and a powder coating composition was obtained by removing fine particles and coarse particles. An average particle diameter of the powder coating composition was 35 μm. A ratio of the total equivalent weights of the equivalent weight of the epoxy group of the epoxy group-containing vinyl-based resin and the equivalent weight of the epoxy group of the epoxy resin to the equivalent weight of the hydroxyl group of the β-hydroxyalkylamide curing agent was 0.23/1, and a ratio of the total equivalent weights of the equivalent weight of the epoxy group of the epoxy group-containing vinyl-based resin, the equivalent weight of the epoxy group of the epoxy resin and the equivalent weight of the hydroxyl group of the β-hydroxyalkylamide curing agent to the equivalent weight of the carboxyl group of the carboxyl group-containing polyester resin was 1.24/1.

Powder Coating Composition 2

An aluminum flake-containing powder coating composition was obtained by mixing well 50.0 g of the above powder coating composition 1 and 5.0 g of PCF 7410B-K (produced by TOYO ALUMINIUM K.K., an aluminum flake pigment having a coat of a resin composition obtained by polymerizing acrylic acid/acrylate/epoxidized polybutadiene/divinyl benzene), which is a resin coat aluminum powder to form a dry blend.

Powder Coating Composition 3

The above powder coating composition 1, 50.0 g and 5.0 g of PCF 7410B-K (produced by TOYO ALUMINIUM K.K., an aluminum flake pigment having a coat of a resin composition obtained by polymerizing acrylic acid-acrylate-epoxidized polybutadiene-divinyl benzene), a resin coat aluminum powder, were well mixed to form a dry blend, and then the resulting dry blend was charged into a high speed blender (produced by PHONIX, 200 ml sealed glass bottle type).

Next, 2.0 g of hydrogenated terpene-phenolic resins (produced by YASUHARA CHEMICAL Co., Ltd., YS Polyster TH-130, number average molecular weight 800, softening point 130° C.) was dissolved in 21.1 g of normal heptane (boiling point 98.4° C.) as a binder with tackiness. This solution was added to the above-mentioned dry blend and the mixture was kneaded well with a spatula so as to be uniform. After the mixture was air-dried for about 1 hour while keeping on kneading, a powder from which dust flies was obtained.

This powder was filled into a 1-liter recovery flask and evaporated at room temperature for further 20 minutes under vacuum with an evaporator while being mixed by rotating the flask. Since a lump of powder due to cohesion was not found in the flask from the observation of the sample, milling of the sample was not particularly carried out. The obtained powder was classified by a screen having 100 μm mesh to obtain a powder coating composition (yield: 97.5%)

Measurement of a content of an aluminum flake pigment and a binding ratio (bonding ratio) were carried out according to the method described in Japanese Kokai Publication 2004-175813, and consequently the content of an aluminum flake pigment in the powder coating composition 3 was 8.2% and the binding ratio (bonding ratio) was 97.5%.

### EXAMPLE 1

The powder coating composition 3 was applied to a tin plate (30 cm×40 cm) and a surface treated aluminum plate (production example 1) at an applied voltage of 80 kV using an electrostatic powder coating machine of a corona discharge type (trade name “MXR-100VT-mini”, produced by ASAHI SUNAC CORPORATION). Then, the powder coating composition was baked at 160° C. for 20 minutes (a retention time of an article to be coated) to prepare a coated plate.

Superlac 5000 AW-10 (acrylic solvent-borne coating composition, produced by Nippon Paint Co., Ltd.) was applied to the obtained coating film by one stage so as to be 40 μm in a dried film thickness as a low-solid solvent clear coating composition, and set for 7 minutes, and then it was heated at 140° C. for 20 minutes to prepare a multilayer coating film.

### EXAMPLE 2

After a powder coating composition was applied and baked by the same method as in Example 1, O-1800 W clear (produced by Nippon Paint Co., Ltd.), as a high-solid solvent clear coating composition, was applied by one stage so as to be 40 μm in a dried film thickness and set for 7 minutes, and then it was heated at 140° C. for 20 minutes to prepare a multilayer coating film.

### EXAMPLE 3

After a powder coating composition was applied and baked by the same method as in Example 1, a clear coating composition Powdax A400 WH (produced by Nippon Paint Co., Ltd.), as a powder clear coating composition, was applied so as to be 80 μm in a dried film thickness and heated at 160° C. for 20 minutes to prepare a multilayer coating film.

### EXAMPLE 4

After a powder coating composition was applied by the same method as in Example 1, it was preheated at 160° C. for 3 minutes.

Superlac 5000 AW-10 (acrylic solvent-borne coating composition, produced by Nippon Paint Co., Ltd.), as a low-solid solvent clear coating composition, was applied to the obtained coating film by one stage so as to be 40 m in a dried film thickness and set for 7 minutes, and then it was heated at 140° C. for 20 minutes to prepare a multilayer coating film.

### EXAMPLE 5

After a powder coating composition was applied by the same method as in Example 1 and preheated at 160° C. for 3 minutes, O-1800 W clear (produced by Nippon Paint Co., Ltd.) was applied by one stage so as to be 40 μm in a dried film thickness as a high-solid solvent clear coating composition, and set for 7 minutes, and then it was heated at 140° C. for 20 minutes to prepare a multilayer coating film.

### EXAMPLE 6

After a powder coating composition was applied by the same method as in Example 1 and preheated at 160° C. for 3 minutes, a clear coating composition Powdax A400 WH (produced by Nippon Paint Co., Ltd.), as a powder clear coating composition, was applied so as to be 80 μm in a dried film thickness, and then it was heated at 160° C. for 20 minutes to prepare a multilayer coating film.

### COMPARATIVE EXAMPLE 1

The powder coating composition 1 was applied to a tin plate (30 cm×40 cm) and a surface treated aluminum plate (production example 1) at an applied voltage of 80 kV using an electrostatic powder coating machine of a corona discharge type (trade name “MXR-100VT-mini”, produced by ASAHI SUNAC CORPORATION). Then, the powder coating composition was baked at 160° C. for 20 minutes (a retention time of an article to be coated) to prepare a coated plate.

Superlac AS70 11SV-14 (acrylic solvent-borne coating composition, produced by Nippon Paint Co., Ltd.) was applied to the obtained coating film so as to be 20 μm in a dried film thickness, and set for 10 minutes, and then it was heated at 140° C. for 20 minutes and cooled to room temperature, and then Superlac 5000 AW-10 (acrylic solvent-borne coating composition, produced by Nippon Paint Co., Ltd.) was applied to the obtained coating film by one stage so as to be 40 μm in a dried film thickness as a low-solid solvent clear coating composition, and set for 7 minutes, and then it was heated at 140° C. for 20 minutes to prepare a multilayer coating film.

### COMPARATIVE EXAMPLE 2

The powder coating composition 2 was applied to a tin plate (30 cm×40 cm) and a surface treated aluminum plate (production example 1) at an applied voltage of 80 kV using an electrostatic powder coating machine of a corona discharge type (trade name “MXR-100VT-mini”, produced by ASAHI SUNAC CORPORATION). Then, the powder coating composition was baked at 160° C. for 20 minutes (a retention time of an article to be coated) to prepare a coated plate.

Superlac 5000 AW-10 (acrylic solvent-borne coating composition, produced by Nippon Paint Co., Ltd.) was applied to the obtained coating film by one stage so as to be 40 μm in a dried film thickness as a low-solid solvent clear coating composition, and set for 7 minutes, and then it was heated at 140° C. for 20 minutes to prepare a multilayer coating film.

Reflectance was evaluated observing the coating film applied onto the tin plate visually.

In addition, unevenness of the reflectance was visually evaluated observing the tin plate (30 cm×40 cm) in its entirety.

◯ (good): reflectance is uniform all over the coating film and the thick and thin of an aluminum flake is not observed.

Δ (bad): an aluminum flake is applied all over the coating film, but a pattern of thick and thin of an aluminum flake can be observed and a blackish portion and a whitish portion are observed in the same coated plate.

x (highly bad): A portion where an aluminum flake is not present apparently can be observed, and a pattern of the thick and thin of an aluminum flake is remarkable.

The results of evaluation of the reflectance and its unevenness are shown in Table 1.

<Performance Evaluation Method>

All of performance evaluations were carried out on a coat applied to a surface treated aluminum alloy (AC-4C) test panel. The results of the evaluations are shown in Table 2.

Adhesion Test

Ten slits were cut at 1 mm pitches in a longitudinal and a lateral directions, respectively, in the coating film of each specimen for the adhesion test with a cutter, and a cellotape was affixed to the slit area and peeled off and the number of squares remaining among 100 squares was counted (crosscut test)

Water Resistance Test

After each specimen for a hot water immersion test was immersed for 72 hours in a hot water of 60° C., the specimen was left standing for 24 hours, and then the same crosscut test as in the above adhesion test was carried out.

Corrosion Resistance Test

A crosscut was made in the surface of each specimen for a salt spray test with a cutter knife, and salt spray was performed at 35° C. for 1200 hours using a 5% by weight of aqueous solution of NaCl, and after leaving the specimen for 24 hours, a degree of corrosion within a width of 2 mm around the crosscut was measured.

◯: there is no abnormality such as blistering of a coating film and rust

x: there is abnormality

Weathering Test

An exposure test of 600 hours was carried out on each specimen for a weathering test with a sunshine weather 0 meter. Then, the specimen was held at 50° C. and 98% in relative humidity for 240 hours, and after leaving the specimen for 24 hours, a crosscut test (100 squares of 1 mm×1 mm) was carried out and peeling and discoloration of the square were investigated on each specimen.

◯: there is not remarkable change in an appearance

x: there is abnormality

TABLE 1

| | | | | | | | | | Comparative | Comparative |
|---|---|---|---|---|---|---|---|---|---|---|
| | | | Example 1 | Example 2 | Example 3 | Example 4 | Example 5 | Example 6 | Example 1 | Example 2 |
| Material | | | tin plate | tin plate | tin plate | tin plate | tin plate | tin plate | tin plate | tin plate |
| Coating | Primer | Coating | powder | powder | powder | powder | powder | powder | powder | powder |
| system | | composition | coating | coating | coating | coating | coating | coating | coating | coating |
| | | name | composition | composition | composition | composition | composition | composition | composition | composition |
| | | | 3 | 3 | 3 | 3 | 3 | 3 | 1 | 2 |
| | Top | Base | — | — | — | — | — | — | solvent | — |
| | coat | | | | | | | | coating | |
| | | | | | | | | | composition | |
| | | Clear | solvent | solvent | powder | solvent | solvent | powder | solvent | solvent |
| | | | coating | coating | coating | coating | coating | coating | coating | coating |
| | | | composition | composition | composition | composition | composition | composition | composition | composition |
| | | | (LS) | (HS) | (PD) | (LS) | (HS) | (PD) | (LS) | (LS) |
| Process merit | | | ◯ | ◯ | ◯ | ◯ | ◯ | ◯ | X | ◯ |
| | | | (2C2B) | (2C2B) | (2C2B) | (2C1B) | (2C1B) | (2C1B) | (3C3B) | (2C2B) |
| Evaluation | Appear- | Reflectance | ◯ | ◯ | ◯ | ◯ | ◯ | ◯ | ◯ | Δ |
| | ance | Unevenness | ◯ | ◯ | ◯ | ◯ | ◯ | ◯ | ◯ | X |

TABLE 2

| | | | | | | | | | Comparative | Comparative |
|---|---|---|---|---|---|---|---|---|---|---|
| | | | Example 1 | Example 2 | Example 3 | Example 4 | Example 5 | Example 6 | Example 1 | Example 2 |
| Material | | | aluminum | aluminum | aluminum | aluminum | aluminum | aluminum | aluminum | aluminum |
| | | | casting plate | casting plate | casting plate | casting plate | casting plate | casting plate | | |
| Treatment | | | non- | non- | non- | non- | non- | non- | non- | non- |
| | | | chromate | chromate | chromate | chromate | chromate | chromate | chromate | chromate |
| Coating | Primer | Coating | powder | powder | powder | powder | powder | powder | powder | powder |
| system | | composition | coating | coating | coating | coating | coating | coating | coating | coating |
| | | name | composition | composition | composition | composition | composition | composition | composition | composition |
| | | 3 | 3 | 3 | 3 | 3 | 3 | 3 | 1 | 2 |
| | Top | Base | — | — | — | — | — | — | solvent | — |
| | coat | | | | | | | | coating | |
| | | | | | | | | | composition | |
| | | Clear | solvent | solvent | powder | solvent | solvent | powder | solvent | solvent |
| | | | coating | coating | coating | coating | coating | coating | coating | coating |
| | | | composition | composition | composition | composition | composition | composition | composition | composition |
| | | | (LS) | (HS) | (PD) | (LS) | (HS) | (PD) | (LS) | (LS) |
| Process merit | | | ◯ | ◯ | ◯ | ◯ | ◯ | ◯ | X | ◯ |
| | | | (2C2B) | (2C2B) | (2C2B) | (2C1B) | (2C1B) | (2C1B) | (3C3B) | (2C2B) |
| Evaluation | Perfor- | Adhesion | ◯(100/100) | ◯(100/100) | ◯(100/100) | ◯(100/100) | ◯(100/100) | ◯(100/100) | ◯(100/100) | ◯(100/100) |
| | mance | test | | | | | | | | |
| | | Corrosion | ◯ | ◯ | ◯ | ◯ | ◯ | ◯ | ◯ | ◯ |
| | | resistance | | | | | | | | |
| | | test | | | | | | | | |
| | | Water | ◯(100/100) | ◯(100/100) | ◯(100/100) | ◯(100/100) | ◯(100/100) | ◯(100/100) | ◯(100/100) | ◯(100/100) |
| | | resistance | | | | | | | | |
| | | test | | | | | | | | |
| | | Weathering | ◯ | ◯ | ◯ | ◯ | ◯ | ◯ | ◯ | ◯ |
| | | test | | | | | | | | |

As is apparent from the results of Examples, it is possible to form a coating film which has an excellent appearance, and an excellent adhesion property and an excellent corrosion resistance in both of two-coat and two-bake process, and two-coat and one-bake process when the powder coating composition of the present invention is used.

The powder coating composition of the present invention can be used for articles to be coated such as an aluminum wheel, which are easily affected by heat, for the purpose of forming a coating film having an excellent appearance.

1. A powder coating composition consisting of a powder coating composition particle,
wherein said powder coating composition particle comprises at least a thermosetting resin powder formed by binding a metallic pigment with a binder and
said thermosetting resin powder comprises a β-hydroxyalkylamide curing agent expressed by the following general formula (1): 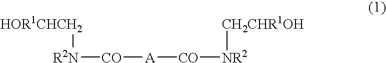
wherein R¹ represents a hydrogen atom, a methyl group or an ethyl group, R² represents a hydrogen atom, an alkyl group having 1 to 5 carbon atoms or HOCH(R¹)CH₂—, and A represents a bivalent hydrocarbon group.

2. The powder coating composition according to claim 1,
wherein said metallic pigment is bound to the surface of said thermosetting resin powder.

3. The powder coating composition according to claim 1,
wherein said metallic pigment is a metallic pigment in flake form.

4. The powder coating composition according to claim 1,
wherein a binding ratio of said metallic pigment to said thermosetting resin powder is 90 to 100%.

5. The powder coating composition according to claim 1,
wherein an average particle diameter of said powder coating composition particles is 100 μm or less on the D50 equivalent basis.

6. The powder coating composition according to claim 1,
wherein said binder is an organic compound having a number average molecular weight of 300 to 2000 and a softening point of 30 to 180° C.

7. The powder coating composition according to claim 1,
wherein said binder is one or more species selected from the group consisting of terpene resins, terpene-phenolic resins, hydrogenated terpene resins and hydrogenated terpene-phenolic resins.

8. The powder coating composition according to claim 1,
wherein said thermosetting resin powder has an average particle diameter of 5 to 50 μm.

9. The powder coating composition according to claim 1,
wherein said powder coating composition particle comprises a carboxyl group-containing polyester resin.

10. The powder coating composition according to claim 1,
wherein said powder coating composition particle further comprises an epoxy group-containing vinyl-based resin and/or an epoxy resin.

11. A coating method of an aluminum wheel,
comprising the steps of:
(1-1) applying the powder coating composition according to claim 1, and
(1-2) curing the applied powder coating composition at a temperature of 150 to 170° C.

12. A coating method of an aluminum wheel,
comprising the steps of:
(2-1) applying the powder coating composition according to claim 1,
(2-2) curing the applied powder coating composition at a temperature of 150 to 170° C.,
(2-3) applying a clear coating composition onto the cured coating film formed by the step (2-2), and
(2-4) curing the applied clear coating composition.

13. A coating method of an aluminum wheel,
comprising the steps of:
(3-1) applying the powder coating composition according to claim 1,
(3-2) applying a clear coating composition onto the coat applied by the step (3-1), and
(3-3) curing the coats applied by the steps (3-1) and (3-2) at a temperature of 150 to 170° C.

14. The powder coating composition according to claim 2,
wherein said metallic pigment is a metallic pigment in flake form.

15. The powder coating composition according to claim 2,
wherein a binding ratio of said metallic pigment to said thermosetting resin powder is 90 to 100%.

16. The powder coating composition according to claim 2,
wherein an average particle diameter of said powder coating composition particles is 100 μm or less on the D50 equivalent basis.

17. The powder coating composition according to claim 2,
wherein said binder is an organic compound having a number average molecular weight of 300 to 2000 and a softening point of 30 to 180° C.

18. The powder coating composition according to claim 2,
wherein said binder is one or more species selected from the group consisting of terpene resins, terpene-phenolic resins, hydrogenated terpene resins and hydrogenated terpene-phenolic resins.

19. The powder coating composition according to claim 2,
wherein said thermosetting resin powder has an average particle diameter of 5 to 50 μm.

20. The powder coating composition according to claim 2,
wherein said powder coating composition particle comprises a carboxyl group-containing polyester resin.
